(19) United States
(12) Patent Application Publication
(10) Pub. No.: US 2012/0111497 A1
(43) Pub. Date: May 10, 2012

(54) COMPLEX EPOXY RESIN ADHESIVE ADDED WITH CARBON NANOTUBES AND METHOD OF USING THE SAME

(75) Inventors: Shih-Chin Chang, Hsinchu City (TW); Tsun-Hsu Chang, Hsinchu City (TW); Tzu-Huan Chiu, Hsinchu City (TW); Tsung-Han Chen, Hsinchu City (TW)

(73) Assignee: National Tsing Hua University, Hsinchu City (TW)

(21) Appl. No.: 12/960,500

(22) Filed: Dec. 4, 2010

(30) Foreign Application Priority Data
Nov. 5, 2010 (TW) 099138068

(51) Int. Cl. B32B 37/12; C08K 3/04; C09J 163/00

(52) U.S. Cl. 156/275.5; 523/468

(57) ABSTRACT

The present invention discloses a complex epoxy resin adhesive added with carbon nanotubes, and the complex epoxy resin adhesive can be prepared in advance and then stored at room temperature. When use, the preheating step is no longer required anymore, and the complex epoxy resin adhesive mixed with carbon nanotubes is coated uniformly onto an adhering position, and microwave is used for heating and curing the adhesive, so as to achieve the dual effects of surpassing the enhanced curing property of a simple epoxy resin and reducing the curing time.

### BACKGROUND OF THE INVENTION

1. Field of the Invention

The present invention relates to a complex epoxy resin adhesive added with carbon nanotubes and a method of using the adhesive, and more particularly to a complex epoxy resin adhesive added with carbon nanotubes and a method of using a microwave heating method to heat the adhesive in order to expedite curing the adhesive.

2. Description of Related Art

In recent years, fiber-reinforced composites of a polymer matrix with the features of a light weight and a high durability are used extensively in industrial components to meet the lightweight requirement.

The fiber-reinforced composite may be damaged during its use, and the damages mainly include a crack of a matrix, a break of a fiber, a debonding caused by a peel-off between the matrix and the fiber, and a delamination of a composite laminate. It is an important subject for manufacturers to find a way to repair and recover the load carrying capability and extend the lifespan of the material after the material is damaged.

In general, the damages including the crack of the matrix, the debonding and the delamination are usually repaired by a boring-and-infusion method. However, if fibers of the composite are damaged, it is necessary to cover the broken fibers by a repair pad to reinforce the loss of strength caused by the break of the fibers.

The repair using repair pads is generally divided into a mechanical repair and a bonded repair, and the concept of the mechanical repair comes from the conventional repair of metal components, but there are existing problems of applying the mechanical repair to fiber composites, since the mechanical repair adopts a rivet joint method which requires boring the repairing component. As a result, stresses are concentrated around the bored hole, and a delamination may occur at the bored hole. In addition, the joint component is usually made of metal, and different coefficients of thermal expansion will produce a thermal residual stress. In addition, there is also an issue of metal corrosion, and water may pass through a repaired portion easily if the mechanical repair method is adopted, and thus the mechanical repair method has the disadvantages of increasing the weight by the additional weight of water, and taking much time and efforts for the repair. The bonded repair generally uses an epoxy resin as an adhesive and requires heating and curing the adhesive for a better adhesion effect, and the conventional heating method uses a heating plate or a heating blanket, but the heat source is conducted from the surface of the material to the interior of the material in such heating process, so that the adhesive cannot be heated uniformly, and the heat may be dissipated to the surroundings easily. Thus, the bonded repair also has the disadvantages of taking much time and wasting energy.

### SUMMARY OF THE INVENTION

It is a primary objective of the present invention to provide a complex epoxy resin adhesive added with carbon nanotubes, and the complex epoxy resin adhesive can be prepared in advanced and stored at room temperature. When use, the conventional preheating step is no longer required, but users can cure a uniformly mixed composite epoxy resin adhesive by a microwave heating process for less than 20 minutes. The invention can achieve the dual effects of surpassing the curing property of a simple epoxy resin and reducing the curing time.

To achieve the foregoing objective, the complex epoxy resin adhesive added with carbon nanotubes in accordance with the present invention comprises an epoxy resin and a plurality of carbon nanotubes, wherein the epoxy resin is a high-temperature curing epoxy resin added with a curing agent, and the content of the added carbon nanotubes is 0.3˜5 wt % (percentage by weight) of the total weight. Since the carbon nanotubes have excellent microwave absorption property and mechanical property, therefore the microwave energy absorbed by the carbon nanotubes can be converted into heat energy, and the epoxy resin can be heated uniformly and comprehensively to achieve a quick bonding and a composite repairing effect and enhance the adhesive strength and the bonding property of the adhesive.

### BRIEF DESCRIPTION OF THE DRAWINGS

The invention, as well as its many advantages, may be further understood by the following detailed description and drawings in which:

FIG. 1A is a graph of bonding strength versus curing time, showing a hardness analysis of a composite epoxy resin adhesive added with different proportions of CNT when an isothermal microwave heating process is performed at 170° C.;

FIG. 1B is a graph of bonding strength versus curing time, showing a hardness analysis of a composite epoxy resin adhesive added with different proportions of CNT when a conventional heating process is performed at 170° C.;

FIG. 2 is a histogram, showing a change of a bonding strength of a composite epoxy resins adhesive having a fiberglass matrix added with different proportions of CNT when different heating processes are performed;

FIG. 3 is a histogram, showing a change of a bending strength of a composite epoxy resins adhesive having a fiberglass matrix added with different proportions of CNT when different heating processes are performed for a repair; and

FIG. 4 is a histogram, showing a change of a bending strength of a composite epoxy resins adhesive having a fiberglass matrix with a 2-mm crack and added with 3 wt % of CNT when repair pads with different lengths are used for a repair.

### DETAILED DESCRIPTION OF THE INVENTION

The complex epoxy resin adhesive added with carbon nanotubes in accordance with the present invention comprises a plurality of carbon nanotubes occupying 0.3˜5 wt % of the total weight; and a high-temperature curing epoxy resin added with a curing agent occupying 95˜99.7 wt % of the total weight.

The method of using the complex epoxy resin adhesive added with carbon nanotubes comprises the following steps:

Coating Step, a composite epoxy resin adhesive containing a plurality of carbon nanotubes with 0.3˜5 wt % of the total weight is coated between two adhering surfaces of adhering objects; and

Heating Step: a microwave heating process is performed at the position of the coated composite epoxy resin adhesive for a predetermined time to cross-link and cure the adhesive.

The heating time of the heating step is less than 20 minutes.

To make it easier for our examiner to understand the complex epoxy resin adhesive added with carbon nanotubes and the method of using the adhesive in accordance with the present invention, the following preferred embodiments together with related drawings are used for illustrating the present invention.

The preparation and properties of the complex epoxy resin adhesive added with carbon nanotubes are described as follows. Carbon nanotubes (CNT) occupying 0.3˜5 wt % of the total weight is mixed with a high-temperature curing epoxy resin added with a curing agent to produce a mixture, and the mixture is placed on a three-axle roller to disperse the carbon nanotubes by shears to obtain a uniformly dispersed composite epoxy resin adhesive.

(1) Tensile Test

Research results (as shown in Table 1) indicate that the composite epoxy resin adhesive of the present invention improves its tensile strength by approximately 4.6% over the epoxy resin adhesive having no CNT and cured by a conventional heating method, and the Young's modulus of the adhesive of the present invention can be improved by approximately 6.2%. Obviously, the complex epoxy resin adhesive added with carbon nanotubes in accordance with the present invention has a better tensile property.

TABLE 1
Tensile Property of Complex Epoxy Resin Adhesive Added with
Carbon Nanotubes in Accordance with the Present Invention

| | Quantity of Carbon nanotubes (wt %) | | | | |
|---|---|---|---|---|---|
| | 0 | 0.5 | 1 | 2 | 3 |
| Tensile Strength (MPa) | 68.62 | 70.78 | 71.77 | 64.59 | 61.07 |
| Increase of Tensile | | 3.1 | 4.6 | −5.8 | −11.0 |
| Strength (%) | | | | | |
| Young's modulus (GPa) | 2.727 | 2.769 | 2.848 | 2.888 | 2.896 |
| Increase of Young's | | 1.5 | 4.4 | 5.9 | 6.2 |
| modulus (%) | | | | | |

(2) Hardness Test

A composite epoxy resin adhesive containing CNT in different percentages by weight of the total weight is coated onto a fiberglass matrix, and the curing effects of adhesive surfaces of the composite epoxy resin adhesive and the epoxy resin adhesive without CNT and heated by a microwave heating method and a conventional heating method to 150° C. and 170° C. respectively are compared, and finally a hardness test is performed to confirm whether or not the curing process is completed. The curing conditions varied with time are observed, and the time required in a curing process until no liquid-state epoxy resin remains on the surface is considered as the reaction completion time, and the results are given in Table 2.

TABLE 2
Influence of Hardening Effect on Composite Epoxy Resin Adhesive
Containing CNT in Different Percentages by Weight of the
Total Weight and heated by a Microwave Heating Method and a Conventional
Heating Method (Hardness Unit: kgw/mm²)

| | Heating Method | | | | | | | |
|---|---|---|---|---|---|---|---|---|
| | Microwave Heating Method | | | | General Heating Method | | | |
| | Heating Temperature | | | | | | | |
| | 150° C. | | 170° C. | | 150° C. | | 170° C. | |
| | Heating Time | | | | | | | |
| | 8 min. | 11 min. | 5 min. | 11 min. | 25 min. | 40 min. | 20 min. | 40 min. |
| 0 wt % | | | | | 19.9 | 20.2 | 20.1 | 20.0 |
| 0.5 wt % | 20.4 | 20.3 | 20.4 | 20.2 | 20.0 | 20.3 | 20.2 | 20.1 |
| 1.0 wt % | 20.6 | 20.6 | 20.5 | 20.4 | 20.3 | 20.4 | 20.3 | 20.3 |
| 2.0 wt % | 20.6 | 20.7 | 20.6 | 20.7 | 20.2 | 20.3 | 20.2 | 20.1 |
| 3.0 wt % | 20.8 | 20.7 | 20.8 | 20.79 | 20.0 | 20.0 | 20.2 | 20.3 |

In Table 2, it takes approximately 25 minutes or over 20 minutes to heat a repairing fiberglass matrix at 150° C. or 170° C. respectively by a conventional heating method to resume the initial hardness of the fiberglass matrix. In other words, the heating time required to achieve a complete repair effect is approximately 25 minutes or over 20 minutes by the conventional heating method. On the other hand, the microwave heating method just requires approximately a curing time of 8 minutes or 5 minutes for the heating at a temperature of 150° C. or 170° C. respectively. Obviously, the microwave heating method can reduce the curing time by ¼ to ⅓ of the curing time required by the conventional heating method.

(3) Single Lap Shear Test

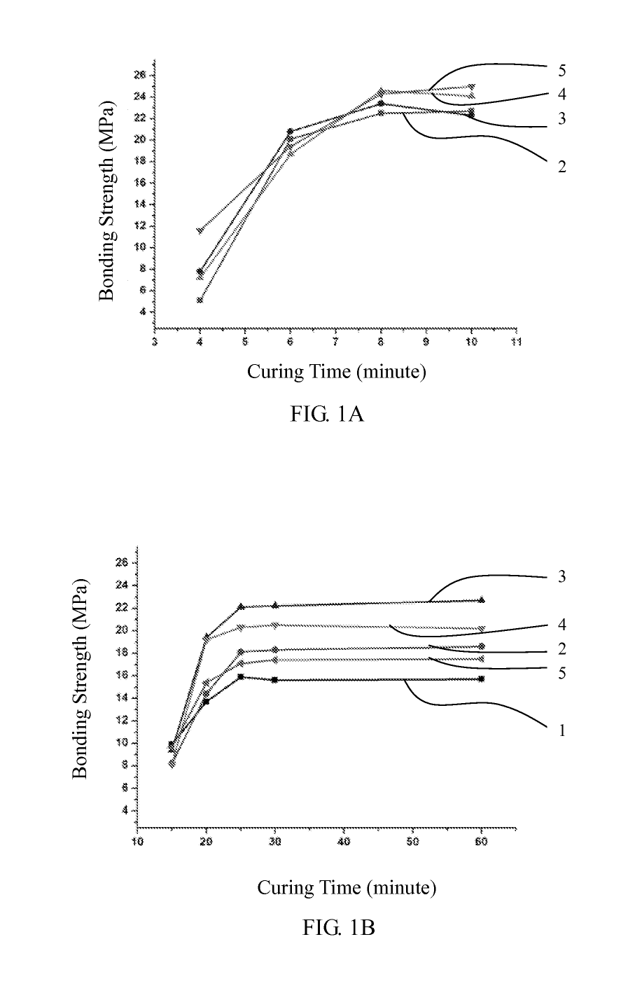

In a single lap shear test, an adhesive is coated between two fiberglass plates, and a Teflon tape is used for controlling the thickness, and the time required for heating the adhesive by different heating methods are compared, and changes of the bonding strengths of the adhesive containing CNT in different percentages and heated by different heating methods are compared, and experiment results are shown in FIGS. 1A and 1B, wherein Nos. 1 to 5 represent composite epoxy resin adhesives with different percentages of CNT equal to 0%, 0.5%, 1.0%, 2.0% and 3.0% of the total weight respectively. In the figures, a conventional heating method is used for heating the adhesive at a temperature of 150° C. or 170° C. for 30 minutes or 25 minutes to achieve a stable strength (wherein the heating result at 150° C. is not shown in the figures). Although the increased temperature can shorten the curing time, it also may damage the joint matrix, so that the method by increasing the temperature cannot be used to further shorten the curing time. On the other hand, the microwave heating method used for heating the adhesive at a temperature of 170° C. requires only 8 minutes of the heating time to achieve the curing effect, and thus the microwave heating method can shorten the curing time without a need of increasing the temperature. Overall speaking, the microwave heating method can reduce the curing time by ⅓ or more, compared with the conventional heating method.

(4) Bonding Strength Test

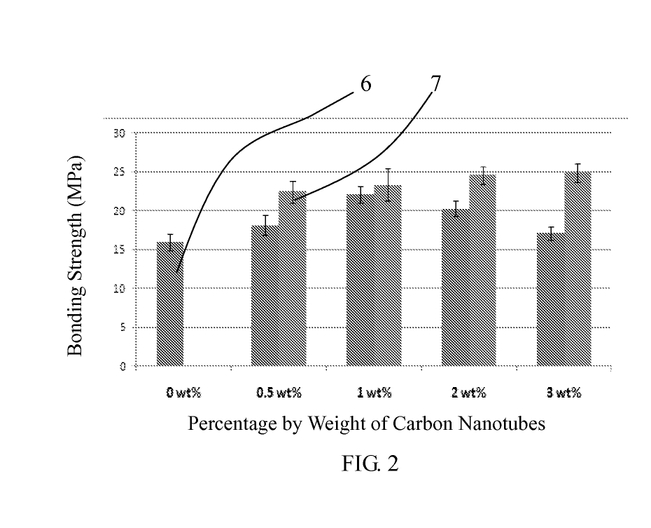

With reference to FIG. 2, No. 6 indicates a change of the bonding strength of a test strip after the conventional heating process takes place, and No. 7 indicates a change of the bonding strength of a test strip after the microwave heating process takes place, and every lighter-gray strip in FIG. 2 indicates the bonding strength of a test strip heated by the microwave heating method. In the figure, the strength of the test strip heated by the conventional heating method is improved by the addition of carbon nanotubes and the decrease of holes, and its maximum bonding strength occurs when the content of carbon nanotubes equals to 1 wt %. If the content of carbon nanotubes exceeds 1 wt %, the cross-link density will drop, and thus the bonding strength will drop as well. On the other hand, the microwave heating method shows no significant decrease of the cross-link density, and thus providing a greater bonding strength, and the bonding strength increases with the content of carbon nanotubes. The bonding strength of a test strip containing 1 wt % of CNT and heated by the conventional heating method is increased by 38% over the pure epoxy resin, and the bonding strength of the test strip containing 3 wt % of CNT and heated by the microwave heating method is increased by 56% over the test strip containing no carbon nanotubes and heated by the conventional heating method.

Under the microscope, we can observe that the fiberglass matrix is damaged by three main causes, respectively: a peel-off between a bonded matrix and an adhesive layer, a damage of the bonded matrix, and an exposure of fibers. In this test, the causes of damage are mainly a damage of the adhesive layer and a damage of the bonded matrix. The stronger the strength of the adhesive layer, the greater damage is the bonded matrix, and the more is the exposure of the fibers. Observations of the cross-section of the bonded test strip heated by the conventional heating method show that the exposure of fibers increases with the content of CNT, but the exposure decreases with the content of CNT after the content of CNT exceeds 1 wt %, and this result complies with the aforementioned change of bonding strengths. Compared with the test strip heated by the conventional heating method, the test strip heated by the microwave heating method has a more severe exposure of fibers, and it shows that the microwave heating method can provide a greater bonding strength.

(5) Repair Test

In this test, the bending strength of the repaired composite is measured by a three-point bending test, and a thread saw is provided for cutting an initial fiberglass plate with a crevice of 2 mm depth, and a repair pad is mended onto the fiber composite, and then the bending strengths of the initial composite, the damaged composite with a 2 mm crevice, and the mended composite are measured.

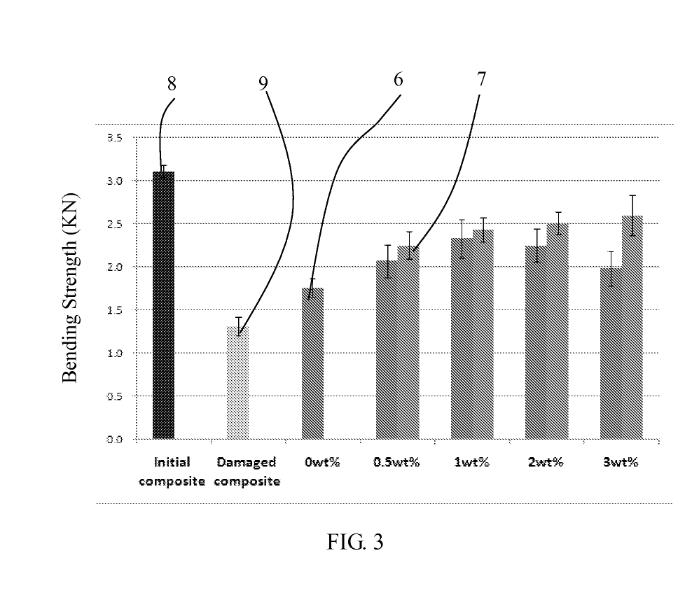

With reference to FIG. 3, this test is performed to a repaired composite with a 13-mm repair pad. Since the repair pad is attached by gluing, therefore the bonding strength depends on the strength after the repair takes place. In FIG. 3, the tendency of a change of strength of the repair pad is the same as the previously measured bonding strength, and the maximum repaired strength of the test strip repaired by the conventional heating method occurs when the content of CNT equals to 1 wt %, and the repaired strength decreases with an increase of the content of CNT. On the other hand, the repaired strength of the test strip repaired by the microwave heating method increases with the content of CNT.

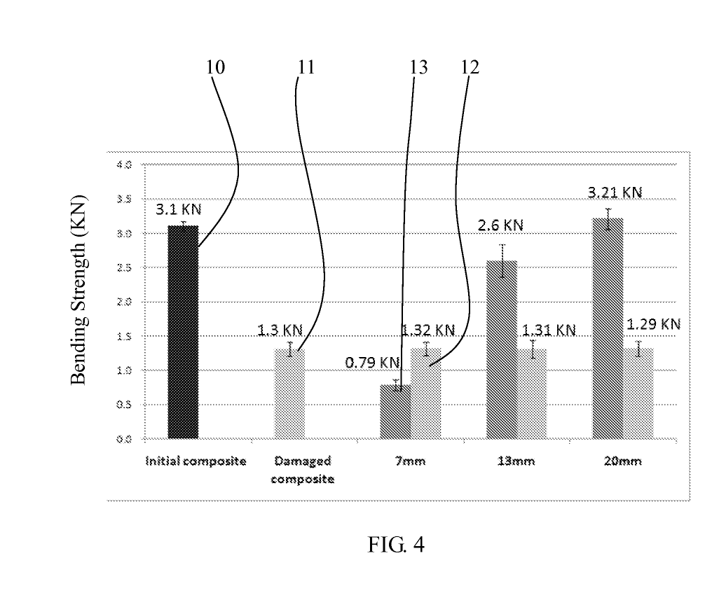

With reference to FIG. 4 for a histogram, showing a change of bending strength of a composite epoxy resins adhesive having a fiberglass matrix with a 2-mm crack and added with 3 wt % of CNT when repair pads of different length are used for the repair, No. 10 represents the bending strength of the initial composite; No. 11 represents the strength of the composite having a 2-mm crevice; No. 12 represents the residual strength after the repair takes place, and the difference of the strength at the second peak value of the bending strength curve, and it shows that the test strip with the crevice has a very good reproducibility; and No. 13 represents the strength of the repair pad, which is the first peak value of the bending strength curve. In the figure, the length of the repair pad is increased, and the repaired strength of the repair pad is also increased. As to the repair pad with a length of 7 mm, the repaired strength is smaller than the strength of the damaged composite, indicating that a too-short repair pad has no substantial repair effect. For a 20-mm repair pad, the repaired strength is greater than the strength of the initial material. In other words, the length of the repair pad must be large enough to have the repaired strength of the repair pad greater than the strength of the damaged composite before an effective repair can be achieved. If the length of the repair pad reaches an optimal value, the repaired strength of the repair pad can be equal to or greater than the strength of the initial material.

In summation of the description above, the added carbon nanotubes can enhance the epoxy resin adhesive. If the epoxy resin adhesive is added with more than 1 wt % of carbon nanotubes and cured by the conventional heating method, the adhesive strength will drop. If the microwave heating method is used, the uniformly dispersed carbon nanotubes in the epoxy resin adhesive are provided for achieving a uniform heating by the heat source, such that the curing time of the epoxy resin can be reduced by ⅓ or better than the curing time required by the conventional heating method. As to the bonding strength, the added carbon nanotubes can reduce the size of the holes produced during the curing process. For the conventional heating method, the bonding strength of the composite epoxy resin adhesive added with 1 wt % of CNT is increased by approximately 38% over the bonding strength of the pure epoxy resin, but if the content of CNT exceeds 1 wt %, the cross-link density of the epoxy resin will decrease greatly, so that the bonding strength will decrease with the content of the carbon nanotubes. For the microwave heating method, the uniformly dispersed carbon nanotubes can generate heat uniformly, and the cross-link density of the epoxy resin will not be affected by the carbon nanotubes easily, so that the bonding strength will increase with the content of the carbon nanotubes. The bonding strength of the composite epoxy resin adhesive added with 3 wt % of CNT is improved by approximately 56% over the bonding strength of a pure epoxy resin cured by the conventional heating method, so that if the microwave heating method is adopted for the repair, the repaired strength of the microwave heating method is greater than the repair strength of the conventional heating method. If the length of the repair pad exceeds a certain value, the repaired strength of the repair pad will be greater than the strength of the damaged material to provide an effective repair. If the length of the repair pad is greater than an optimal value, the repaired strength of the repair pad can be equal to or greater than the strength of the initial material.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A complex epoxy resin adhesive added with carbon nanotubes, comprising:
a plurality of carbon nanotubes, occupying a percentage by weight of 0.3˜5 wt % of the total weight of the adhesive and the carbon nanotubes; and
a high-temperature curing epoxy resin, added with a curing agent, and occupying a percentage by weight of 95˜99.7 wt % of the total weight of the adhesive and the carbon nanotubes.

2. A method of using a complex epoxy resin adhesive added with carbon nanotubes, comprising:
a coating step, that coats a composite epoxy resin adhesive containing a plurality of carbon nanotubes between adhering surfaces of two objects, and the carbon nanotubes occupy a percentage by weight of 0.3˜5 wt % of the total weight of the adhesive and the carbon nanotubes; and
a heating step, that performs a microwave heating at the position of coating the composite epoxy resin adhesive to cross-link and cure the adhesive for a predetermined time.

3. The method of claim 2, wherein the heating step takes a heating time less than 20 minutes.

4. The method of claim 2, wherein the composite epoxy resin adhesive comprises a high-temperature curing epoxy resin added with a curing agent.
